(19) United States
(12) Patent Application Publication
(10) Pub. No.: US 2025/0282432 A1
(43) Pub. Date: Sep. 11, 2025

(54) STRUCTURAL FLOOR TRANSPORT SYSTEM

(71) Applicant: Shipps Group, LLC, Dahlonega, GA (US)

(72) Inventors: Peter Shipps, Dahlonega, GA (US); Amanda Jordan, Dahlonega, GA (US)

(73) Assignee: Shipps Group, LLC, Dahlonega, GA (US)

(21) Appl. No.: 19/077,048

(22) Filed: Mar. 11, 2025

Related U.S. Application Data
(60) Provisional application No. 63/563,941, filed on Mar. 11, 2024.

(51) Int. Cl. B62D 53/06; B62D 53/08

(52) U.S. Cl. CPC B62D 53/061; B62D 53/08

(57) ABSTRACT

A foundation floor transport system for use in combination with a transport vehicle includes a frame that is sized and configured for selective coupling with a tongue adapter and an axle adapter, defining a transport configuration, wherein a tongue adapter attached to the tongue adapter is secured to the transport vehicle for transporting the frame; and wherein the tongue adapter and axle adapter may be selectively coupled to each other, defining a return haul configuration

### CROSS REFERENCE TO RELATED APPLICATIONS

The present application claims the priority of U.S. Provisional Patent Application Ser. No. 63/563,941 filed Mar. 11, 2024, entitled “FOUNDATION FLOOR TRANSPORT SYSTEM”, which is incorporated herein in its entirety.

### BACKGROUND

A typical construction of mobile homes and park model RVs generally utilizes long structural steel beams, across which the floor joists are installed perpendicular to these beams. Floor decking is installed and the floor system is complete. This system can be anywhere from 16″ to 22″ in thickness. Then, in order to be transported, a set of axles is installed under the center of the frame, which raises the floor to a height of 36″ to 42″ above the road surface for transport. The resulting “Design Height” for the structure above the floor is thereby limited to 10′ to 10′-6″ due to the 13′6″ allowable height mandate set by the U.S. Department of Transportation, causing the structure to have a relatively “squatty” appearance, which limits design options.

Traditional mobile home construction is very stringent on the weight of materials used in their construction. This translates downward to the required strength of the frame to support these loads. The goal of typical mobile home construction is ultimately to be at a reduced cost and weight as compared to other construction methods. Keeping weight to a minimum allows for the use of less expensive steel for the foundation frame. The result of this type of construction is that the frame will be somewhat “flexible”. Moreover, tiny homes are traditionally built on an “equipment hauler” variety of trailer frame. These trailers are used to move heavy equipment like tractors, cars or other motor vehicles, and are individually rated for their maximum load, as mandated by several factors including the capacity of the steel in the frame, as well as the capacity and quantity of the axles under the trailer.

Lastly, traditional mobile frames are transported on a series of axles fastened to the underside of their frame. The tongue hitch of a mobile home is bolted to the underside of the frame, raising the front end of the unit off of the ground. This adds height to the system, again reducing the design height for the finalized home structure.

In view of the problems associated with presently available frame and associated transport systems, there is a need for a system for minimizing the height of a structure's frame, wherein the frame remains close to the ground or road surface during transport, while increasing the design height of the finalized structure.

### SUMMARY

In accordance with one form of the present invention, there is provided a structural floor transport system including an engineered structural steel perimeter I-Beam floor frame within which various types of floor joists, engineered trusses, Structural Insulated Panels (SIPs), or steel bar joists can be installed to create a complete floor system. The floor system is designed to span the length of the frame without intermediate support, providing a rigid platform for building transportable structures.

### BRIEF DESCRIPTION OF THE DRAWINGS

For a fuller understanding of the nature of the present invention, reference should be made to the following detailed description, taken in conjunction with the accompanying drawings in which:

FIG. 1 is a perspective view of the structural floor transport system and a semi-truck;

FIG. 2 is a perspective view of the structural floor transport system;

FIG. 3 is a perspective view of the structural floor transport system;

FIG. 4 is a perspective view of the structural floor transport system;

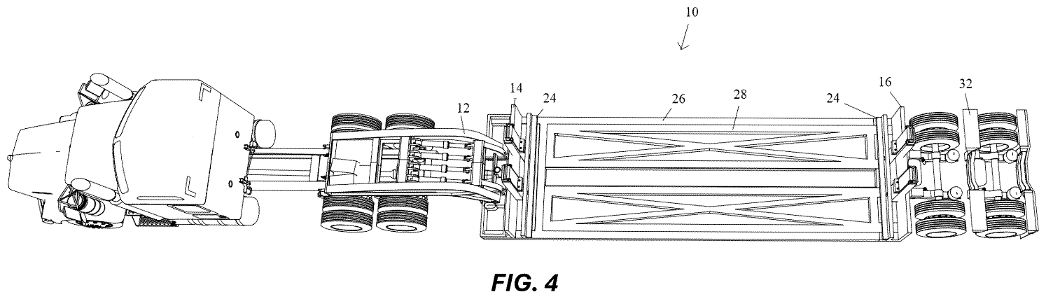

FIG. 5 is a perspective view of the structural floor transport system;

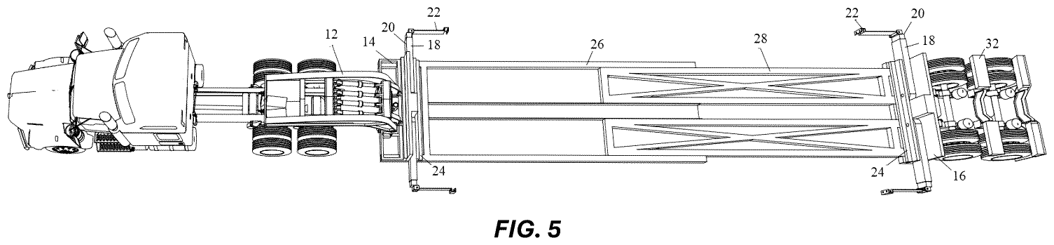

FIG. 6 is a perspective view of the structural floor transport system;

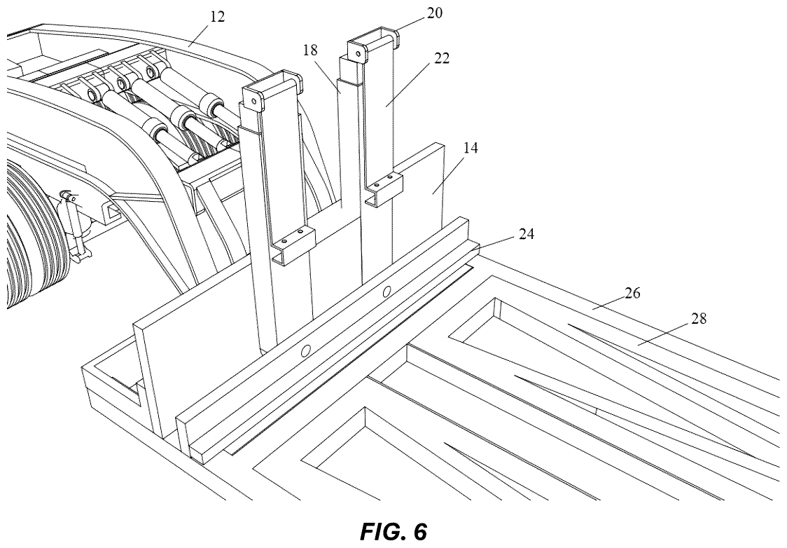

FIG. 7 is a perspective view of the structural floor transport system;

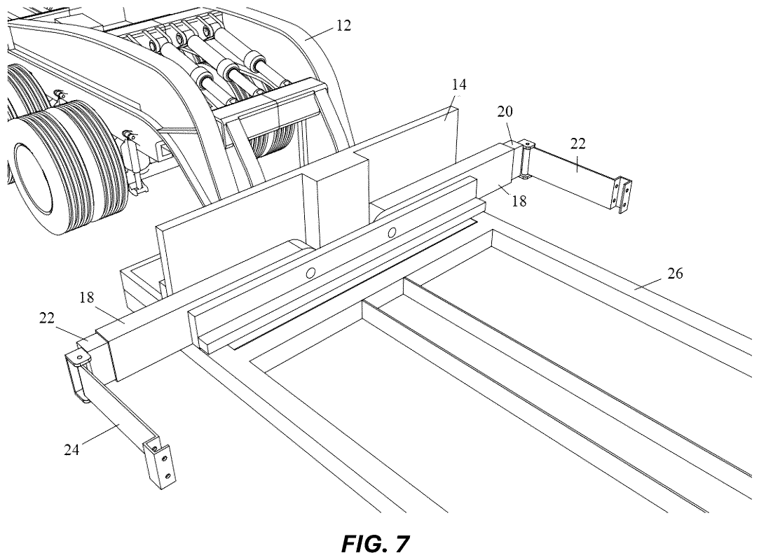

FIG. 8 is an isolated perspective view of the structural floor transport system;

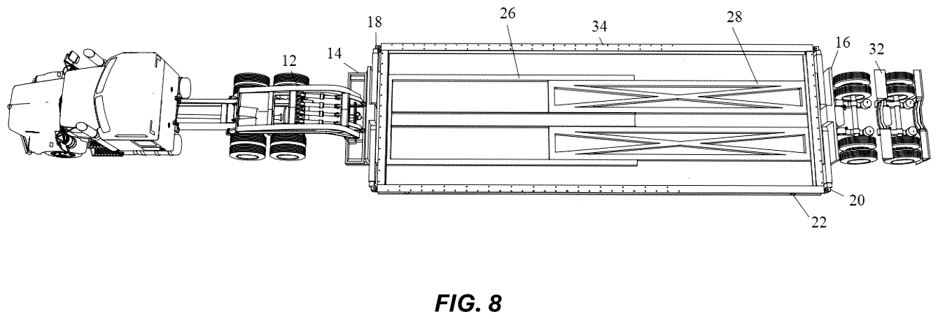

FIG. 9 is a side elevation view of the structural floor transport system;

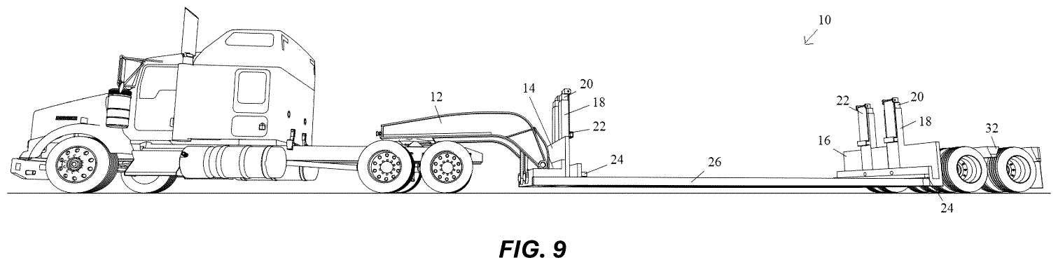

FIG. 10 is a perspective view of the structural floor transport system;

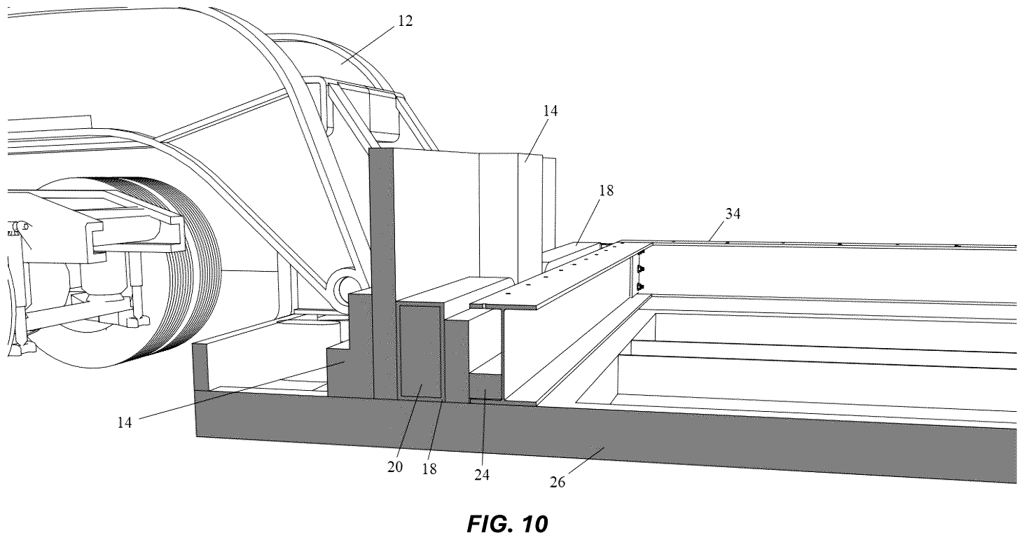

FIG. 11 is an isolated perspective view of the structural floor transport system;

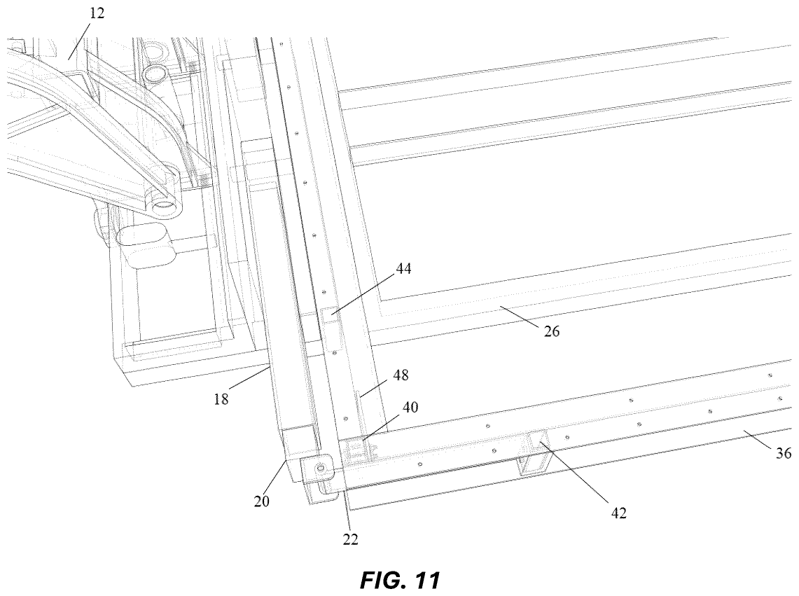

FIG. 12 is an isolated perspective view of the structural floor transport system;

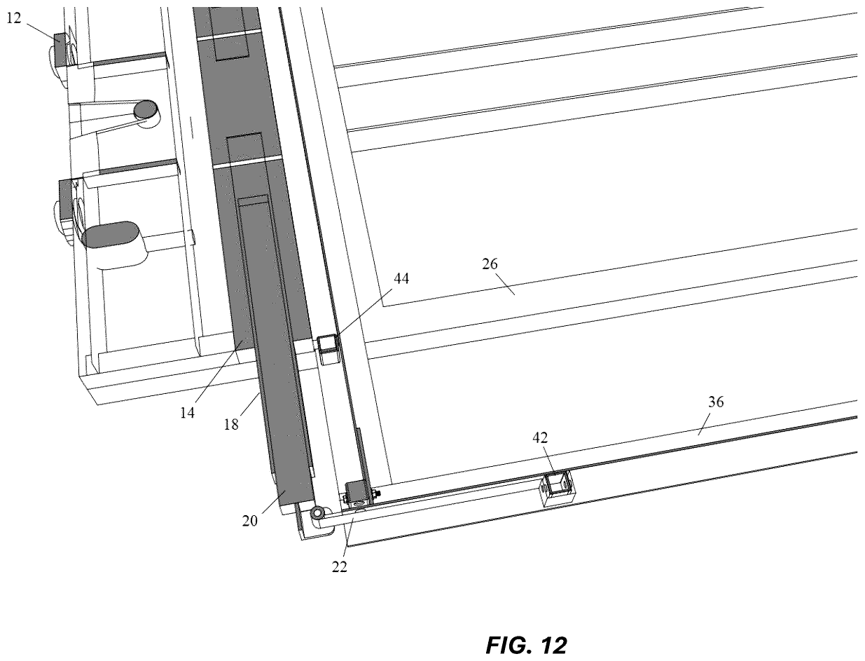

FIG. 13 is a perspective view of the frame; and

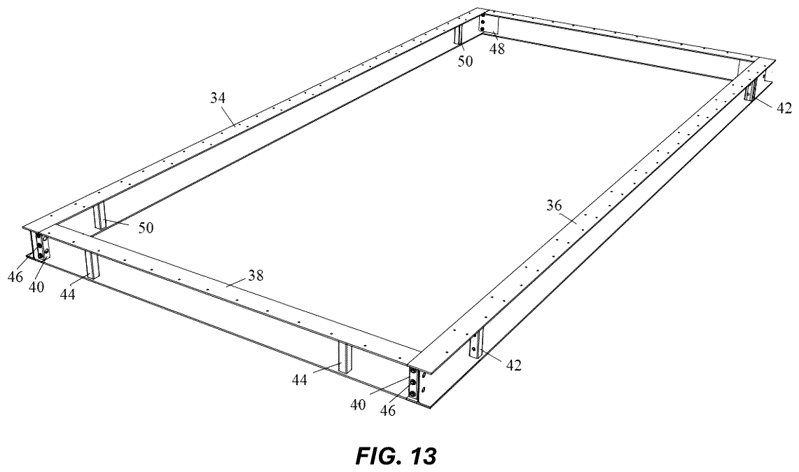

FIG. 14 is a perspective view of the frame.

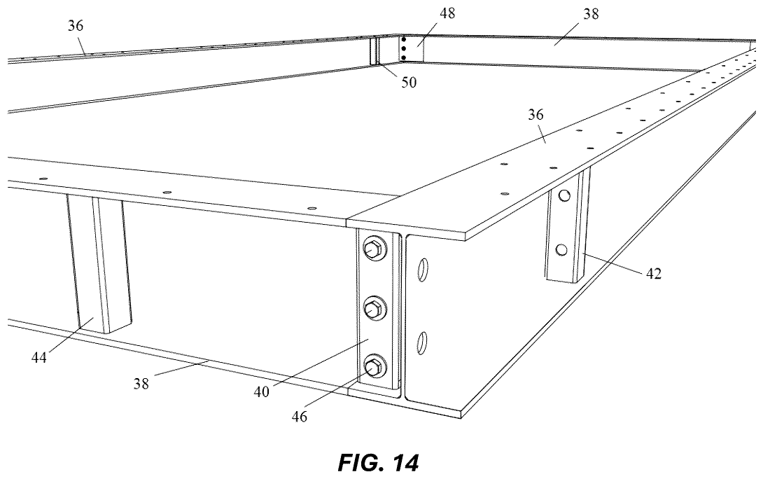

Like reference numerals refer to like parts throughout the several views of the drawings.

### DETAILED DESCRIPTION

Referring to the several views of the drawings, the structural floor transport system of the present invention for use in combination with a transport vehicle 100 is shown and is generally indicated as 10. The floor transport system 10 can be constructed to a variety of dimensions with the limiting factor being transportation size restrictions imposed by Department of Transportation or other agencies. The structural floor transport system 10 includes an engineered structural steel perimeter I-Beam floor frame within which various types of floor joists, engineered trusses, Structural Insulated Panels (SIPs), or steel bar joists can be installed to create a complete floor system. The floor system is designed to span the length of the frame without intermediate support, providing a rigid platform for building transportable structures.

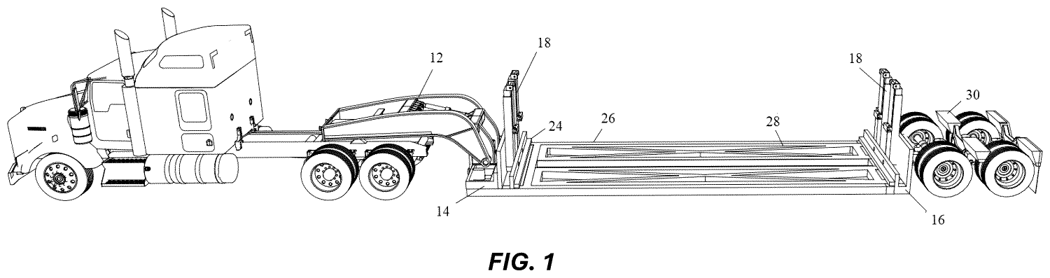

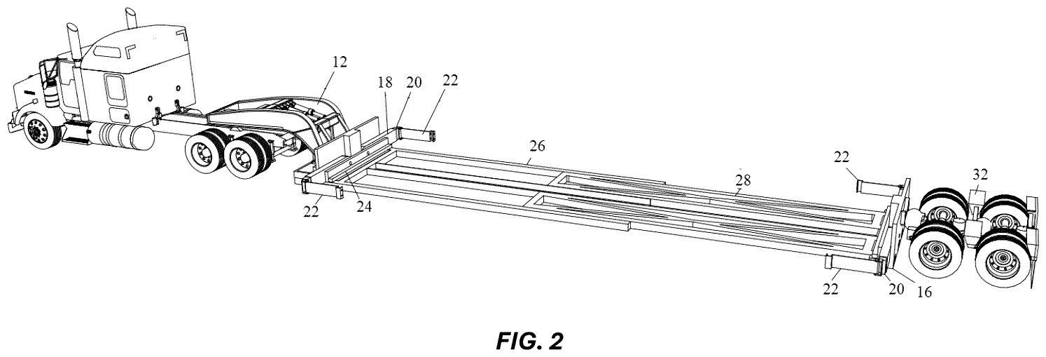

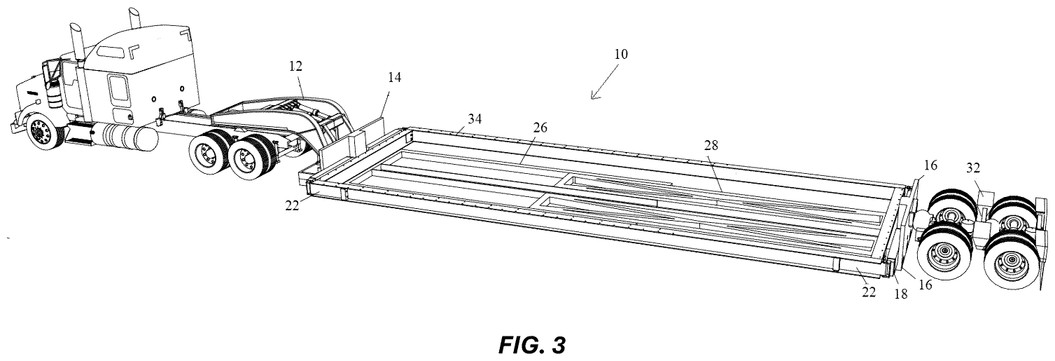

Referring initially to FIGS. 1-3, the structural floor transport system 10 is shown. The transport system is designed to interface with a floor structure in a low-profile configuration. The structural floor transport system 10 connects to a transport vehicle 100 using a standard 5th wheel plate connection or other connection and features front and rear steel bulkheads that can be raised or lowered as needed in different hauling modes, including loading/unloading mode, standard transport mode, and ground clearance mode.

In accordance with one embodiment, the gooseneck hitch 12, which is a hydraulically adjustable connector used to connect to a semi-truck 5th wheel plate, is connected to the tongue bulkhead assembly 14, which in turn connects to the front carriage frame 26. The tongue bulkhead assembly 14 houses pivoting retaining sleeves 18 and a frame capture bar 24 to secure the frame end beam 38.

The axle bulkhead assembly 16 connects the rear carriage frame 28 to the axle assembly 32. It also houses pivoting retaining sleeves 18 and a frame capture bar 24 to secure the frame end beam 38. The pivoting retaining sleeve 18 is a rectangular steel tube attached to the tongue and axle bulkhead assemblies, capable of pivoting from vertical to horizontal positions. These sleeves contain extendable retaining arms 20 to capture the width of the frame assembly 34.

The extendable retaining arm 20 is a rectangular steel component designed to fit within the pivoting retaining sleeves 18 for lateral adjustment. These arms lock into position and have pivoting retaining clasps 22 to secure the frame assembly 34. The pivoting retaining clasp 22 connects the extendable retaining arms 20 to the frame retention tubes 42, providing additional security. These clasps are secured with retaining pins through aligned holes.

The frame capture bar 24 is installed on the tongue bulkhead assembly 14 and axle bulkhead assembly 16. These bars 24 capture the lower flanges of the frame end beams 38 as the extendable frame collapses onto the frame assembly 34. The front carriage frame 26 connects to the tongue bulkhead assembly and interfaces with the rear carriage frame 28 to extend from 24′ to 40′ in length. The rear carriage frame 28 connects the front carriage frame to the axle bulkhead assembly, maintaining the connection in an extendable manner.

The axle assembly 32 is a standard pair of equipment axles affixed to the axle bulkhead assembly 16. These axles can be raised and lowered using air or hydraulic mechanisms. The frame assembly 34 is the structural floor system component.

The frames are low-profile steel tubes designed to maintain the connection between the front and rear components of the transport system in an extendable manner. The attachment pins 30 secure the pivoting retaining clasps 22 to the frame floor system at the frame retention tubes 42 on the frame 34. The axle assembly 32 features the ability to raise and lower using air-driven or hydraulic mechanisms. Generally, the frame assembly 34 is the structural floor system component. It includes structural steel I-beams for the sides 36 and ends 38, corner assembly tubes 40, retention tubes 42, lateral stability tubes 44, assembly bolts 46, web extension plates 48, and web stiffener tubes 50. These components work together to provide a stable and rigid platform for building transportable structures. The transport system can operate in four modes: dead haul/return mode, loading/unloading mode, transport mode, and ground clearance mode. Each mode is designed to accommodate specific functional requirements, ensuring the efficient and safe transport of structures built on the frame floor system. The frame side beam 36 is a structural steel I-beam that forms the long sides of the frame 34. The frame end beam 38 is another structural steel I-beam that makes up the narrow ends of the frame 24. These beams are connected at the corners by the corner assembly tubes 40, which are structural steel tubes designed to join the frame side beams 36 with the frame end beams 38. To secure the transport system to the frame 34, retention tubes 42 are affixed to the exterior side of the frame side beams 36 in alignment with the pivoting retaining clasps 22. For additional stability, lateral stability tubes 44 are attached to the exterior side of the frame end beams 38 to align with the frame capture bars 24, ensuring the lateral position of the Uni-Frame is maintained with the tongue bulkhead assembly 14 and the axle bulkhead assembly 16. The assembly bolts 46 are engineered steel bolts with washers and nuts used to connect the frame side beams 36 to the frame end beams 38 through the corner assembly tubes 40. To create the corners of the frame 34, web extension plates 48 are used to connect the frame side beams 36 to the frame end beams 38. Finally, web stiffener tubes 50 are incorporated into the design to add necessary stiffness to the corners of the frame floor system, ensuring the overall rigidity and stability of the structure. These components collectively contribute to the robust and adaptable nature of the frame assembly, making it suitable for various construction and transport applications.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. For brevity and/or clarity, well-known functions or constructions may not be described in detail herein.

The terms “for example” and “such as” mean “by way of example and not of limitation.” The subject matter described herein is provided by way of illustration for the purposes of teaching, suggesting, and describing, and not limiting or restricting. Combinations and alternatives to the illustrated embodiments are contemplated, described herein, and set forth in the claims.

For convenience of discussion herein, when there is more than one of a component, that component may be referred to herein either collectively or singularly by the singular reference numeral unless expressly stated otherwise or the context clearly indicates otherwise. For example, components N (plural) or component N (singular) may be used unless a specific component is intended. Also, the singular forms “a,” “an,” and “the” are intended to include the plural forms as well, unless expressly stated otherwise or the context indicates otherwise.

It will be further understood that the terms “includes,” “comprises,” “including,” and/or “comprising” specify the presence of stated features, steps, operations, elements, and/or components, but do not preclude the presence or addition of one or more other features, steps, operations, elements, components, and/or groups thereof unless explicitly stated otherwise or the context clearly requires otherwise. The terms “includes,” “has” or “having” or variations in form thereof are intended to be inclusive in a manner similar to the term “comprises” as that term is interpreted when employed as a transitional word in a claim.

It will be understood that when a component is referred to as being “connected” or “coupled” to another component, it can be directly connected or coupled or coupled by one or more intervening components unless expressly stated otherwise or the context clearly indicates otherwise.

The term “and/or” includes any and all combinations of one or more of the associated listed items. As used herein, phrases such as “between X and Y” and “between about X and Y” should be interpreted to include X and Y unless expressly stated otherwise or the context clearly indicates otherwise.

Terms such as “about”, “approximately”, and “substantially” are relative terms and indicate that, although two values may not be identical, their difference is such that the apparatus or method still provides the indicated or desired result, or that the operation of a device or method is not adversely affected to the point where it cannot perform its intended purpose. As an example, and not as a limitation, if a height of “approximately X inches” is recited, a lower or higher height is still “approximately X inches” if the desired function can still be performed or the desired result can still be achieved.

While the terms vertical, horizontal, upper, lower, bottom, top, and the like may be used herein, it is to be understood that these terms are used for ease in referencing the drawing and, unless otherwise indicated or required by context, does not denote a required orientation.

The different advantages and benefits disclosed and/or provided by the implementation(s) disclosed herein may be used individually or in combination with one, some or possibly even all of the other benefits. Furthermore, not every implementation, nor every component of an implementation, is necessarily required to obtain, or necessarily required to provide, one or more of the advantages and benefits of the implementation.

Conditional language, such as, among others, “can”, “could”, “might”, or “may”, unless specifically stated otherwise, or otherwise understood within the context as used, is generally intended to convey that certain embodiments preferably or optionally include certain features, elements and/or steps, while some other embodiments optionally do not include those certain features, elements and/or steps. Thus, such conditional language indicates, in general, that those features, elements and/or step may not be required for every implementation or embodiment.

The subject matter described herein is provided by way of illustration only and should not be construed as limiting the nature and scope of the subject invention. While examples of aspects of the subject invention have been provided above, it is not possible to describe every conceivable combination of components or methodologies for implementing the subject invention, and one of ordinary skill in the art may recognize that further combinations and permutations of the subject invention are possible. Furthermore, the subject invention is not necessarily limited to implementations that solve any or all disadvantages which may have been noted in any part of this disclosure. Various modifications and changes may be made to the subject invention described herein without following, or departing from the spirit and scope of, the exemplary embodiments and applications illustrated and described herein. Although the subject matter presented herein has been described in language specific to components used therein, it is to be understood that the subject invention is not necessarily limited to the specific components or characteristics thereof described herein; rather, the specific components and characteristics thereof are disclosed as example forms of implementing the subject invention. Accordingly, the disclosed subject matter is intended to embrace all alterations, modifications, and variations, that fall within the scope and spirit of any claims that may be written, for the subject invention.

The foregoing detailed description is intended only to convey to a person having ordinary skill in the art the fundamental aspects of the invention and is not intended to limit, and should not be construed as limiting, the scope of the invention.

1. A structural floor system and transport apparatus comprising:
a structural steel perimeter I-Beam floor frame sized and configured to incorporate various types of floor joists, engineered trusses, Structural Insulated Panels (SIPs), or steel bar joists to create a complete floor system, wherein the floor system spans the length of the frame without intermediate support;
a transport system designed to interface with the structural steel perimeter I-Beam floor frame in a low-profile configuration, the transport system comprising:
a gooseneck hitch hydraulically adjustable to connect to a semi-truck 5th wheel plate;
a tongue bulkhead assembly connected to the gooseneck hitch and housing pivoting retaining sleeves and a frame capture bar;
an axle bulkhead assembly connected to the rear carriage frame and housing pivoting retaining sleeves and a frame capture bar;
pivoting retaining sleeves attached to the tongue bulkhead assembly and the axle bulkhead assembly, configured to pivot from a vertical to horizontal position and containing extendable retaining arms;
extendable retaining arms designed to slip within the pivoting retaining sleeves for lateral adjustment to fit the width of the structural steel perimeter I-Beam floor frame and lock into position;
pivoting retaining clasps attached to the end of the extendable retaining arms (E) to secure the structural steel perimeter I-Beam floor frame;
frame capture bars installed on the tongue bulkhead assembly and the axle bulkhead assembly to capture the lower flanges of the structural steel perimeter I-Beam floor frame;
front carriage frame connected to the tongue bulkhead assembly and interfacing with the rear carriage frame to extend from a 24′ length to a 40′ length;
rear carriage frame connecting the front carriage frame to the axle bulkhead assembly;
attachment pins securing the pivoting retaining clasps to the structural steel perimeter I-Beam floor frame;
axle assembly affixed to the axle bulkhead assembly with the ability to raise and lower using air-driven or hydraulic mechanisms;
structural steel I-beams for the sides and ends of the structural steel perimeter I-Beam floor frame;
corner assembly tubes connecting the frame side beams (M) with the frame end beams;
retention tubes affixed to the exterior side of the frame side beams (M) to align with the pivoting retaining clasps;
lateral stability tubes affixed to the exterior side of the frame end beams (N) to align with the frame capture bars;
assembly bolts connecting the frame side beams to the frame end beams through the corner assembly tubes;
web extension plates creating the corners of the structural steel perimeter I-Beam floor frame;
web stiffener tubes adding necessary stiffness to the corners of the structural steel
perimeter I-Beam floor frame;
wherein the transport system is configured to operate in multiple modes including dead haul/return mode, loading/unloading mode, transport mode, and ground clearance mode.
